(19) United States
(12) Patent Application Publication
(10) Pub. No.: US 2025/0287423 A1
(43) Pub. Date: Sep. 11, 2025

(54) METHOD RELATED TO SIDELINK OPERATION IN UNLICENSED BANDS, USER EQUIPMENT, AND BASE STATION

(71) Applicant: SHARP KABUSHIKI KAISHA, Sakai City, Osaka (JP)

(72) Inventors: HAI-HAN WANG, Taipei (TW); YUNG-LAN TSENG, Taipei (TW)

(21) Appl. No.: 18/861,330

(22) PCT Filed: Apr. 28, 2023
(86) PCT No.: PCT/CN2023/091829

§ 371 Date: Oct. 29, 2024

Related U.S. Application Data
(60) Provisional application No. 63/336,967, filed on Apr. 29, 2022.

(51) Int. Cl. H04W 74/0808; H04W 72/25

(52) U.S. Cl. CPC H04W 74/0808; H04W 72/25

(57) ABSTRACT

A method, a user equipment (UE), and a base station for a sidelink operation in unlicensed bands are provided. A UE receives an RRC message, receives a PSSCH in an unlicensed channel, and attempts to transmit a feedback message in a first PSFCH in response to receiving the PSSCH. In a case that the first channel access procedure is not successful, the UE further attempts to transmit the feedback message in a second PSFCH. The RRC message includes a minimum gap between the earliest slot of multiple logical slots of the PSFCHs and a logical slot of the PSSCH, and the logical slots of PSFCHs are assigned for the PSSCH. The UE performs a first channel access procedure in the unlicensed channel before the first PSFCH. The UE performs a second channel access procedure in the unlicensed channel before the second PSFCH.

### CROSS-REFERENCE TO RELATED APPLICATION(S)

The present application is a National Stage Application of International Patent Application Serial No. PCT/CN2023/091829, filed on Apr. 28, 2023, which claims the benefit of and priority to U.S. Provisional Patent Application Ser. No. 63/336,967, filed on Apr. 29, 2022, the contents of all of which are hereby incorporated herein fully by reference in their entirety for all purposes.

### TECHNICAL FIELD

The present disclosure generally relates to wireless communications, and more particularly, to a method related to sidelink operation in unlicensed bands, user equipment, and a base station.

### BACKGROUND

With the tremendous growth in the number of connected devices and the rapid increase in user/network traffic volume, various efforts have been made to improve different aspects of wireless communication for the next-generation wireless communication system, such as the fifth generation (5G) New Radio (NR), by improving data rate, latency, reliability, and mobility. The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC).

In Rel-16 NR, operation in unlicensed bands in 5 GHz and the 6 GHz (e.g., US 5925-7125 MHz, or European 5925-6425 MHz, or parts thereof) taking into account regional regulatory requirements is supported after completion of the NR-U WI. NR-U can support load-based equipment (LBE) operation mode and Frame-based equipment (FBE) operation mode as specified in ETSI EN 301 893.

In Rel-16 NR, sidelink communication for providing the advanced V2X services identified by 3GPP SA1 was specified under the WI on 5G V2X with NR sidelink. Although NR sidelink was initially developed for V2X applications, there is growing interest in the industry to expand the applicability of NR sidelink to commercial use cases. For commercial sidelink applications, two key requirements have been identified:
Increased sidelink data rate;
Support of new carrier frequencies for sidelink.

Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum.

### SUMMARY

The present disclosure is directed to a method related to sidelink operation in unlicensed bands, a user equipment (UE), and a base station.

According to one or more exemplary embodiments of the disclosure, a method related to sidelink operation in unlicensed bands adapted for a UE is provided. The method includes, but is not limited thereto, receiving a radio resource control (RRC) message, receiving a physical sidelink shared channel (PSSCH) in an unlicensed channel, and attempting to transmit feedback message in a first physical sidelink feedback channel (PSFCH) of PSFCHs in response to receiving the PSSCH. In a case that the first channel access procedure is not succeeded, the method further includes attempting to transmit the feedback message in a second PSFCH of the PSFCHs. The RRC message includes a minimum gap between the earliest slot of multiple logical slots of the PSFCHs and a logical slot of the PSSCH, and the logical slots of PSFCHs are assigned for the PSSCH. Attempting to transmit the feedback message in the first PSFCH includes performing a first channel access procedure in the unlicensed channel before the first PSFCH. Attempting to transmit the feedback message in the second PSFCH includes performing a second channel access procedure in the unlicensed channel before the second PSFCH.

According to one or more exemplary embodiments of the disclosure, a UE is provided. The UE includes, but is not limited to, a transceiver, one or more non-transitory computer-readable media having computer-executable instructions embodied thereon, and at least one processor coupled to the transceiver and the one or more non-transitory computer-readable media. The processor is configured to execute the computer-executable instructions to: receive, through the transceiver, a RRC message, receive, through the transceiver, a PSSCH in an unlicensed channel, and attempt to transmit, through the transceiver, feedback message in a first PSFCH of PSFCHs in response to receiving the PSSCH. The processor is configured to: attempt to transmit, through the transceiver, the feedback message in a second PSFCH of the PSFCHs. The RRC message includes a minimum gap between the earliest slot of multiple logical slots of the PSFCHs and a logical slot of the PSSCH, and the logical slots of PSFCHs are assigned for the PSSCH. Attempting to transmit the feedback message in the first PSFCH includes performing a first channel access procedure in the unlicensed channel before the first PSFCH. Attempting to transmit the feedback message in the second PSFCH includes performing a second channel access procedure in the unlicensed channel before the second PSFCH.

According to one or more exemplary embodiments of the disclosure, a base station is provided. The base station includes, but is not limited to, a transceiver, one or more non-transitory computer-readable media having computer-executable instructions embodied thereon, and at least one processor coupled to the transceiver and the one or more non-transitory computer-readable media. The processor is configured to execute the computer-executable instructions to: transmit, through the transceiver, a RRC message. The RRC message includes a minimum gap between the earliest slot of multiple logical slots of the PSFCHs and a logical slot of the PSSCH, and the logical slots of PSFCHs are assigned for the PSSCH.

### BRIEF DESCRIPTION OF DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 is a schematic diagram illustrating a SCI indicates three PSSCH for a TB.

FIG. 2 is a schematic diagram illustrating a SCI indicates PSSCH for the next TB.

FIG. 3 is a schematic diagram that illustrates a radio communication network architecture according to an exemplary embodiment of the present disclosure.

FIG. 4 is a schematic diagram illustrating TX UE acquired COT according to an exemplary embodiment of the present disclosure.

FIG. 5 is a schematic diagram illustrating gNB acquired COT with TX UE and RX UE according to an exemplary embodiment of the present disclosure.

FIG. 6 is a schematic diagram illustrating interlace resource allocation according to an exemplary embodiment of the present disclosure.

FIG. 7 is a flow chart of a method adapted for a UE according to an exemplary embodiment of the present disclosure.

FIG. 8 is a schematic diagram illustrating additional slots used for PSFCHs according to an exemplary embodiment of the present disclosure.

FIG. 9 is a schematic diagram illustrating re-evaluation when LBT fails according to an exemplary embodiment of the present disclosure.

FIG. 10 is a flow chart of a method adapted for a base station according to an exemplary embodiment of the present disclosure.

FIG. 11 is a block diagram illustrating a node for wireless communication according to one of the exemplary embodiments of the disclosure.

### DESCRIPTION OF EMBODIMENTS

The acronyms in the present disclosure are defined as follows and unless otherwise specified, the acronyms have the following meanings:

| Acronym | Full name |
|---|---|
| 3GPP | 3^{rd} Generation Partnership Project |
| 5GC | 5G Core |
| ACK | Acknowledgement |
| AGC | Automatic Gain Control |
| ARFCN | Absolute Radio Frequency Channel Number |
| ARQ | Automatic Repeat Request |
| BS | Base Station |
| BWP | Bandwidth Part |
| CA | Carrier Aggregation |
| CN | Core Network |
| CORESET | Control Resource Set |
| C-RNTI | Cell-Radio Network Temporary Identifier |
| DC | Dual Connectivity |
| DCI | Downlink Control Information |
| DMRS | DeModulation Reference Signal |
| DL | Downlink |
| HARQ | Hybrid Automatic Repeat Request |
| IE | Information Element |
| MAC | Medium Access Control |
| MCG | Master Cell Group |
| MIB | Master Information Block |
| MIMO | Multiple Input Multiple Output |
| NG-RAN | Next-Generation Radio Access Network |
| NR | New Radio |
| NW | Network |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PRACH | Physical Random Access Channel |
| PSBCH | Physical Sidelink Broadcast Channel |
| PSCCH | Physical Sidelink Control Channel |
| PSFCH | Physical Sidelink Feedback Channel |
| PSSCH | Physical Sidelink Shared Channel |
| PUCCH | Physical Uplink Control Channel |
| PUSCH | Physical Uplink Shared Channel |
| RA | Random Access |
| RACH | Random Access Channel |
| RAN | Radio Access Network |
| RB | Resource Block |
| Rel | Release |
| RLC | Radio Link Control |
| RNTI | Radio Network Temporary Identifier |
| RRC | Radio Resource Control |
| SCell | Secondary Cell |
| SCG | Secondary Cell Group |
| SCS | Sub Carrier Spacing |
| SDAP | Service Data Adaptation Protocol |
| SDU | Service Data Unit |
| SFN | System Frame Number |
| SI | System Information |
| SpCell | Special Cell |
| SRB | Signaling Radio Bearer |
| SSB | Synchronization Signal Block |
| TS | Technical Specification |
| UCI | Uplink Control Information |
| UE | User Equipment |
| UL | Uplink |

Some terms would be introduced first.

BWP: A subset of the total cell bandwidth of a cell is referred to as a Bandwidth Part (BWP) and beamwidth part adaptation is achieved by configuring the UE with BWP(s) and telling the UE which of the configured BWPs is currently the active one. To enable Bandwidth Adaptation (BA) on the PCell, the gNB configures the UE with UL and DL BWP(s). To enable BA on SCells in case of CA, the gNB configures the UE with DL BWP(s) at least (i.e. there may be none in the UL). For the PCell, the initial BWP is the BWP used for initial access. For the SCell(s), the initial BWP is the BWP configured for the UE to first operate at SCell activation. UE may be configured with a first active uplink BWP by a firstActiveUplinkBWP IE. If the first active uplink BWP is configured for an SpCell, the firstActiveUplinkBWP IE field contains the ID of the UL BWP to be activated upon performing the RRC (re-) configuration. If the field is absent, the RRC (re-) configuration does not impose a BWP switch. If the first active uplink BWP is configured for an SCell, the firstActiveUplinkBWP IE field contains the ID of the uplink bandwidth part to be used upon MAC-activation of an SCell.

Configured Grant (CG): A UE in RRC_CONNECTED state may be provided with (UL) CG(s). A CG may be a Type-1 CG or a Type-2 CG. For a Type-1 CG, UE may directly use the CG for uplink transmission after receiving the CG configuration. For a Type-2 CG, UE may not directly use the CG for uplink transmission after receiving the CG configuration. To use the CG for uplink transmission, UE needs to receive an activation DCI activating the CG. A CG configuration includes time domain symbol allocation, frequency resource allocation, DMRS configuration, modulation and coding scheme (MCS), periodicity, number of repetitions, number of HARQ processes, etc. PUSCH occasions configured by the CG configuration occur periodically in time domain with the configured periodicity. Within each period, there are PUSCH occasions in consecutive slots when the number of repetitions is greater than 1, and the number of consecutive slots is equal to the number of repetitions. That is to say, one slot contains one PUSCH occasion which may be used for one repetition, and each PUSCH occasion is with the same symbol allocation. The HARQ process ID for a PUSCH occasion is determined based on the system frame number and the slot number corresponding to the slot in which the PUSCH occasion is located.

### Point A:

Point A serves as a common reference point for resource block grids and is obtained from:
offsetToPointA for a PCell downlink where offsetToPointA represents the frequency offset between point A and the lowest subcarrier of the lowest resource block, which overlaps with the SS/PBCH block used by the UE for initial cell selection, expressed in units of resource blocks assuming 15 kHz subcarrier spacing for FR1 and 60 kHz subcarrier spacing for FR2;
for operation without shared spectrum channel access, the lowest resource block has the subcarrier spacing provided by the higher layer parameter subCarrierSpacingCommon;
for operation with shared spectrum channel access, the lowest resource block has the subcarrier spacing same as the SS/PBCH block used by the UE for initial cell selection;
absoluteFrequencyPointA for all other cases where absoluteFrequencyPointA represents the frequency-location of point A expressed as in ARFCN.

### RB Set:

For a UE supporting wideband operation, the nominal intra-cell guard bands and the corresponding sizes of the RB sets separated by the said guard bands are as specified in Table (1) for each UE channel bandwidth and sub-carrier spacing for the downlink and uplink. The nominal intra-cell guard bands in Table 5.3.3-2 are applicable when the respective IE intraCellGuardBandsUL-List and intraCellGuardBandsDL-List [7] for the uplink and downlink are not provided, as specified in 3GPP TS 38.214 clause 7.

TABLE 1
Nominal intra-cell guard bands for wideband operation

| SCS (kHz) | 40 MHz | 60 MHz | 80 MHz |
|---|---|---|---|
| 15 | 105-6-105 | N/A | N/A |
| | (216) | | |
| 30 | 50-6-50 | 50-6-50-6-50 | 50-6-50-5-50-6-50 |
| | (106) | (162) | (217) |
| 60 | 23-5-23 | 23-5-23-5-23 | 23-5-23-5-23-5-23 |
| | (51) | (79) | (107) |

NOTE 1:
The intra-cell guard band is denoted TBW₀-GB₀- . . . -GB_{N}_{_{—}}_{RBset-2}-TBW_{N}_{_{—}}_{RBset-1} for N_RBset > 1 number of RB-sets with TBWᵣ the maximum transmission bandwidth (PRB) of RB-set r and GBᵣ the guard band (PRB) above the upper edge of RB-set r. The RB-set 0 is starting at the first common resource block (CRB) of the carrier as indicated by offsetToCarrier. The total transmission bandwidth configuration (size of resource grid) including guard bands is given in between parentheses.

It is noted that the bandwidth of a RB set is less than 20 MHz, which is the Nominal Channel Bandwidth for a single Operating Channel as defined in ETSI EN 301 893.

Search space configuration may include configuration of PDCCH monitoring periodicity and offset, search space type, and COREST identifier.

### CORESET/Search Space:

A DCI is transmitted via PDCCH by a gNB to a UE using one or more control channel elements (CCE) contained in a CORESET. Configurations of a CORESET include configuration of the PRBs of which the frequency domain resource is used for the CORESET and include configuration of the number of OFDM symbols that defines the time duration of the CORESET. One or more search spaces may be associated with a CORESET. A search space defines the frequency of occurrence of the associated CORESET, and one occurrence of the CORESET may be referred as a monitoring occasion. Configurations of a search space include configuration of the periodicity and time offset of the search space and configuration of the duration of the search space, i.e., the consecutive number of slots in which one or more monitoring occasions exist. If duration is configured as one, there is only one slot in which monitoring occasion(s) exist in each period. Configurations of a search space also include configuration of the type of the search space, i.e., UE specific search space (USS) or common search space (CSS), and the DCI format(s) that are monitored in the search space. Configurations of a search space also include configuration of the number of PDCCH candidates per aggregation level (AL). It is noted that a search space may also be referred as a search space set. After being configured with the CORESETs and the search spaces, the UE attempts to decode the PDCCH candidates based on the configurations, which is also referred as PDCCH monitoring.

Some technologies would be introduced first.

### Cross Carrier Scheduling:

A DCI transmitted in a first cell can be used to schedule a PDSCH or a PUSCH in a second cell. The first cell is also referred as the scheduling cell, and the second cell is also referred as the scheduled cell. To indicate the PDSCH or the PUSCH is scheduled in the second cell, a carrier indicator field can be configured in DCI format 0_1, DCI format 1_1, DCI format 0_2, or DCI format 1_2 in the first cell, which indicates a value associated with the second cell. The value of the carrier indicator field that is used to indicate the second cell is configured via the CrossCarrierSchedulingConfig IE in the ServingCellConfig IE for the second cell, and the serving cell index of the first cell is also indicated in the CrossCarrierSchedulingConfig IE.

It is noted that a scheduled cell can only have one scheduling cell, and a scheduled cell cannot be scheduled by itself. That is, if the UE is configured to monitor PDCCH in a first cell for scheduling a second cell, the UE is not configured to monitor PDCCH in the second cell. On the other hand, a scheduling cell cannot be a scheduled by another scheduling cell. That is, if the UE is configured to monitor PDCCH in a first cell for scheduling a second cell, the UE is configured to monitor PDCCH in the first cell for scheduling the first cell, and the UE is not configured to monitor PDCCH in a third cell for scheduling the first cell.

In the present disclosure, an unlicensed band may also be referred as a shared spectrum.

Nr with Shared Spectrum Channel Access:

NR with shared spectrum channel access may operate in different modes where either PCell, PSCell, or SCells can be in shared spectrum and an SCell may or may not be configured with uplink. The applicable deployment scenarios are described in the following.
Scenario A: Carrier aggregation between NR in licensed spectrum (PCell) and NR in shared spectrum (SCell);
   A.1: SCell is not configured with UL (DL only); A.2: SCell is configured with UL (DL+UL).
Scenario B: Dual connectivity between LTE in licensed spectrum and NR in shared spectrum (PSCell);
Scenario C: NR in shared spectrum (PCell);
Scenario D: NR cell in shared spectrum and uplink in licensed spectrum;
Scenario E: Dual connectivity between NR in licensed spectrum (PCell) and NR in shared spectrum (PSCell).

For PUCCH and PUSCH, PRB interlace structure is introduced to meet occupied channel bandwidth (OCB) requirement and boost transmit power under power spectral density (PSD) limitation. For 30 KHz SCS, M=5 interlaces are defined. For 15 KHz SCS, M=10 interlaces are defined. The interlaces are defined with respect to point A as specified in 3GPP TS 38.211, and one interlace is formed by set of resource blocks, each of which is M RBs apart.

For PUCCH, Rel-15 NR PUCCH format 0/1/2/3 are extended to PRB interlace waveform similar to PUSCH, but constrained within one RB set. PUCCH format 0/1 in Rel-15 is single RB only, while in Rel-16, they are extended to one interlace with 10 or 11 RBs. PUCCH format 2/3 in Rel-15 are already multiple RBs but in continuous RBs up to 16 RBs. In Rel-16, they are extended to occupy one or two interlaces.

To gain access in an unlicensed band, clear channel assessment (CCA) is required according to ETSI EN 301 893. CCA may also be referred as listen before talk (LBT). Rel-16 NR-U supports two channel access operation modes: dynamic channel access mode (corresponds to Load Based Equipment in ETSI EN 301 893) and semi-static channel access mode (corresponds to Frame Based Equipment in ETSI EN 301 893).

When operating on a wideband (i.e. >20 MHz) carrier, CCA is performed in the unit of a RB set which is with bandwidth of 20 MHz or 10 MHz depending on regulation requirements.

For dynamic channel access mode, the following LBT mechanisms are defined: Cat 4 LBT with a contention window (Type 1 channel access procedures as specified in 3GPP TS 37.213);
Cat 2 LBT within a 25 μs sensing interval (Type 2A channel access procedures as specified in 3GPP TS 37.213); Cat 2 LBT within a 16 μs gap (Type 2B channel access procedures as specified in 3GPP TS 37.213);
Cat 1 LBT with a gap of no more than 16 μs without channel sensing (Type 2C channel access procedures as specified in 3GPP TS 37.213).

When the gNB or the UE transmits a transmission on a channel after performing Cat 4 LBT, it is said that the gNB or the UE acquired a COT or initiated a COT on the channel.

Both gNB and UE can acquire a COT with Cat 4 LBT, while a gNB or UE can share the COT acquired by the other node with Cat 2 or Cat 1 LBT under different conditions. More specifically, when the UE shares a COT acquired by the gNB or vice versa, if the gap between two transmissions by the UE and the gNB is 25 μs or 16 μs, Type 2A channel access procedures and Type 2B channel access procedures are used respectively to share the COT. If the gap between two transmissions by the UE and the gNB is up to 16 μs, Type 2C channel access procedures is used to share the COT. Furthermore, the COT initiator may perform a transmission on the channel within the MCOT by Type 2A channel access procedures, Type 2B channel access procedures, and Type 2C channel access procedures, if the gap between a previous transmission and the transmission is 25 μs, 16 μs, and up to 16 μs, respectively. The only exception is the transmission of discovery reference signal (DRS), which includes the transmission of SSBs and other non-unicast control and data, where under some restrictions, Cat 2 LBT can be used to acquire the COT.

Using Cat 4 LBT, the gNB or the UE may transmit a transmission after firstly sensing the channel to be idle during the sensing slot durations of a defer duration T_{d} and after a counter N is equal to 0. The value of N is randomly selected in a range from 0 to CWₚ before the Cat 4 LBT procedure starts, where CWₚ is the size of the contention window associated with channel access priority class (CAPC) p. The counter N may be decremented by 1 if an additional sensing slot duration Tₛₗ is sensed to be idle. If an additional sensing slot duration Tₛₗ has not been sensed to be idle, the gNB or the UE senses the channel until either a busy sensing slot is detected within an additional defer duration T_{d} or all the sensing slots of the additional defer duration T_{d} are detected to be idle. If it is the latter case, the counter N may be decremented by 1 and the gNB or the UE may continue sensing N additional sensing slot durations Tₛₗ. If it is the former case, the step for sensing an additional defer duration T_{d} repeats. If N is equal to 0, the gNB or the UE may transmit a transmission on the channel. The defer duration T_{d} consists of duration T_{f}−16 μs immediately followed by mₚ consecutive sensing slot durations Tₛₗ, and T_{f} includes an idle sensing slot duration Tₛₗ at start of T_{f}.

The channel access parameters channel access priority class p associated with the gNB transmissions defined in 3GPP TS 37.213 are shown in Table (2). The channel access parameters channel access priority class p associated with the UE transmissions defined in 3GPP TS 37.213 are shown in Table (3).

TABLE 2
Channel Access Priority Class (CAPC) associated
with the gNB transmissions:

| Channel | | | | | |
|---|---|---|---|---|---|
| Access | | | | | |
| Priority | | | | | allowed CWₚ |
| Class (p) | mₚ | CW_{min, p} | CW_{max, p} | T_{m cot, p} | sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

TABLE 3
Channel Access Priority Class (CAPC)
associated with the UE transmissions:

| Channel | | | | | |
|---|---|---|---|---|---|
| Access | | | | | |
| Priority | | | | | allowed CWₚ |
| Class (p) | mₚ | CW_{min, p} | CW_{max, p} | T_{mulcot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

A Channel Occupancy Time (COT) refers to the total time for which the gNB or the UE that acquired a channel by performing Type 1 channel access procedures and the gNB or the UE sharing the channel occupancy perform transmission(s) on the channel. For determining a COT, if a transmission gap is less than or equal to 25 μs, the gap duration is counted in the channel occupancy time. T_{mcot,p} and T_{ulmcot,p} is the maximum COT for CAPC p associated with the gNB transmissions and the UE transmissions, respectively.

CAPC can be configured for each data radio bearer (DRB) and SRB2. The signaling bearers (except for SRB2) always use the highest priority CAPC (n=1). The gNB assigns the CAPC by taking into account the specified mapping between 5QI (QOS indicator) of QoS flows in a DRB. The UE uses this configuration to determine the CAPC when not signaled by the gNB directly via DCI. This applies to all CG transmissions and some dynamic grants (scheduled by DCI format 0_0 or DCI format 1_0). When signaling data is transmitted, i.e, when a DCCH SDU is included in a MAC PDU, CAPC of the MAC PDU is same as the CAPC of the highest priority signaling bearer. In all other cases, the lowest priority CAPC among the multiplexed data flows is chosen for the CAPC of the MAC PDU.

For semi-static channel access, in Rel-16 NR-U, only gNB can contend for a channel at a fixed frame period (FFP) boundary and a UE can share the gNB COT for transmission if gNB DL transmission is detected in the same COT.

### Sidelink Physical Channels:

For sidelink communication (e.g., LTE V2X sidelink communication service/NR sidelink communication services/LTE sidelink communication service/LTE sidelink discovery service/Prose communication service/ProSe discovery service), a SL BWP is configured which includes TX resource pools and RX resource pools. TX resource pools are used for transmitting SL physical channels and SL physical signals by TX UEs. RX resource pools are used for receiving SL physical channels and SL physical signals by RX UEs. A TX UE may also be a RX UE. Configurations of the sidelink physical channels and sidelink physical signals are per resource pool.

The following physical channels are introduced for sidelink communication.

Physical sidelink broadcast channel (PSBCH) is used to carry the SL MIB. PSBCH is transmitted together with SL synchronization signal (SLSS) in the same slot. SLSS and SS PSBCH may be referred as SL SSB. SLSS and PSBCH is transmitted by RRC CONNECTED UEs that are indicated by the gNB as synchronization source UEs. Other UEs not indicated by the gNB as synchronization source UEs may also transmit SLSS and PSBCH under some conditions. For example, when the measured Reference Signal Received Power (e.g., RSRP) of the cell is below a threshold. The SLSS and PSBCH is received by UEs not directly synchronized with the gNB or the GNSS. That is, the UEs not directly synchronized with the gNB or the GNSS selects a synchronization source UE as a synchronization reference (SyncRef) UE. It is noted that a synchronization source UE may also be synchronized with other SyncRef UE.

In a resource pool, up to 27 subchannels may be configured. The minimum size of a subchannel that may be configured is 10 PRBs, and the maximum size of a subchannel that may be configured is 100 PRBs.

Physical sidelink control channel (PSCCH) is used to carry sidelink control information (SCI) by a TX UE to a RX UE. The number of symbols for PSCCH is configured, which can be two or three symbols. The starting symbol of PSCCH is determined as symbol x, where x=sl-StartSymbol+1, where sl-StartSymbol is the starting symbol configured for sidelink communication in slots without SL-SSB. More than one PSCCHs may be present in a slot, each of which is transmitted by different TX UEs. At most one PSCCH is transmitted in a subchannel. The starting PRB (the PRB with lowest PRB index) of a PSCCH is the starting PRB of a subchannel.

Physical sidelink shared channel (PSSCH) is used to carry sidelink shared channel (SL-SCH) transport channel which may include data or control signaling. The starting symbol of PSSCH is the same as PSCCH in PRBs not containing PSCCH. In other PRBs, the starting symbol of PSSCH is the first symbol after the end symbol of PSCCH. The end symbol of PSSCH is symbol y1 in a slot not containing PSFCH, where y1=sl-StartSymbol+sl-LengthSymbols−2, since the last symbol configured for sidelink communication is reserved as a guard symbol. The end symbol of PSSCH is symbol y2 in a slot containing PSFCH, where y2=sl-StartSymbol+sl-LengthSymbols−5, since PSFCH is with 2 symbols and one symbol immediately before the PSFCH and one symbol immediately after the PSFCH are reserved as a guard symbols. The first symbol configured for sidelink communication, i.e. symbol x−1, is used for AGC purpose for the RX UEs. Transmission of symbol x−1 is a duplication of the PSCCH, PSSCH, DM-RS, PT-RS, or CSI-RS in symbol x.

More than one PSSCHs may be present in a slot, each of which is transmitted by different TX UEs. PSSCH may comprise one or more subchannel. The number of subchannels of a PSSCH are indicated in the SCI scheduling the PSSCH. The SCI scheduling the PSSCH is transmitted in the PSCCH in the same slot. The starting subchannel is the subchannel that contains the PSCCH in which the scheduling SCI is transmitted. SCI in two stages. The first-stage SCI is carried in PSCCH and contains information to enable sensing operations, as well as information about the resource allocation of the PSSCH. PSSCH transmits the second-stage SCI. The second-stage SCI carries information needed to identify and decode the transport block (TB) transmitted in the PSSCH, as well as control for hybrid automatic repeat request (HARQ) procedures, and triggers for channel state information (CSI) feedback, etc.

Physical sidelink feedback channel (PSFCH) is used to carry HARQ-ACK feedback from a RX UE to a TX UE. PSFCH is with 2 symbols where the first symbol, which is used for AGC purpose for the TX UE receiving the PSFCH, is a duplication of the second symbol. The second symbol of PSFCH is located in symbol y1, where y1=sl-StartSymbol+sl-LengthSymbols−2. PSFCH is configured with a periodicity N (via sl-PSFCH-Period-r16), N can be 0, 1, 2, or 4 logical slots, where N=0 means there is no PSFCH in the resource pool. For N=1, 2, or 4, PSFCH is present in logical slots with logical slot index #0, #N, #2N, . . . within a 10240 ms period.

A PSFCH is with 1 PRB. A RX UE may transmit multiple PSFCH corresponding to PSSCH transmitted by multiple TX UEs. The maximum number of PSFCH a UE can simultaneously transmit depends on UE capability and power limitation.

A set of PRBs in a slot configured for PSFCHs are mapped to the slots with associated PSSCHs firstly in increasing slot indexes of PSSCH slots, and secondly in increasing subchannel indexes. More specifically, within a set of PRBs configured for PSFCH in a slot (referred as the PSFCH slot), the first Z PRBs in the PSFCH slot are mapped to the first subchannel in the first slot with associated PSSCH, the second Z PRBs in the PSFCH slot are mapped to the first subchannel in the second slot with associated PSSCH, and so on. After all slots with associated PSSCH are mapped for the first subchannel, the next Z PRBs in the PSFCH slot are mapped to the second subchannel in the first slot with associated PSSCH, and so on.

### Logical Slot:

For sidelink communication, a set of slots is determined from the slots for each 10240 ms period. To determine the set of slots, the slots for SL SSB transmission and the slots with in which one or more symbols for sidelink communication is indicated as DL or flexible by tdd-UL-DL-ConfigurationCommon are excluded. Afterwards, a bitmap is used to determine which of the remaining slots is included in the set of slots. The set of slots is then consecutively indexed starting index 0. The indexes are referred as logical slot indexes, and the set of slots are referred as logical slots.

### Sidelink MIB:

The following IEs are included in SL MIB. sl-TDD-Config is used to indicate the TDD configuration to a UE that receives the SL MIB. When a synchronization source UE sets the content of sl-TDD-Config, it should be set to the same meaning as tdd-UL-DL-ConfigurationCommon if tdd-UL-DL-ConfigurationCommon is included in the SIB1 broadcasted by the gNB and if the synchronization source UE has not selected a SyncRef UE. More specifically, sl-TDD-Config indicates the number of slots in a period that may be used for sidelink communication (PSCCH/PSSCH/PSFCH), which is determined based on the number of UL slots with all UL symbols, the number of UL symbols in a slot preceding the UL slots with all UL symbols, and the starting symbol for sidelink communication indicated by sl-StartSymbol. When a synchronization source UE sets the content of sl-TDD-Config, it should be set to the same as a sl-TDD-Config received from a SyncRef UE selected by the synchronization source UE.

| MasterInformationBlockSidelink ::= SEQUENCE { | |
|---|---|
| sl-TDD-Config-r16 | BIT STRING (SIZE (12)), |
| inCoverage-r16 | BOOLEAN, |
| directFrameNumber-r16 | BIT STRING (SIZE (10)), |
| slotIndex-r16 | BIT STRING (SIZE (7)), |
| reservedBits-r16 | BIT STRING (SIZE (2)) |

}

### Resource Allocation Modes:

There are two resource allocation modes: mode 1 and mode 2. For a UE in RRC_CONNECTED, if sl-ScheduledConfig is configured, Mode 1 is used. If sl-UE-SelectedConfig is configured, Mode 2 is used. For UEs not in RRC_CONNECTED, Mode 2 is used. Mode 2 operation for UEs not in RRC_CONNECTED may be based on the configuration provided in SL-ConfigCommonNR configured via system information or based on configuration provided in SL-PreconfigurationNR by higher layer. In Mode 1, resource allocation is done by gNB. In Mode 2, the UE autonomously selects the resource.

In mode 1, gNB can dynamically schedule a TX UE by a DCI (format 3_0), or configure resource for a TX UE by Type 1 or Type 2 configured grant via RRC signalling and DCI respectively, which is similar to UL configured grants. A DCI indicates information including the resource pool and the subchannel in which a SCI should be transmitted by the TX UE, and including the contents of the SCI.

In Mode 2, resource selection procedure triggered in slot n includes the following steps.
Step 1: Identification of candidate resources within a resource selection window.
Step 2: Resource selection for (re-) transmission(s) from the identified candidate resources.

Identification of candidate resources is based on the sensing results in a sensing window. The sensing window is from slot n-T0 to slot n-T_{proc,0}, where T0 is a number of slots which is equal to 100 ms or 1100 ms, and T_{proc,0} is 1, 1, 2, and 4 for SCS of 15 kHz, 30 kHz, 60 kHz, and 120 kHz, respectively. Sensing comprises decoding SCIs and measuring SL RSRP on the DMRS of the PSCCH carrying the decoded SCIs or measuring SL RSRP on the DMRS of the PSSCHs scheduled by the SCIs. The resource selection window is from slot n+T1 to slot n+T2, where T1 is equal to T_{proc,1}^{SL} as shown in Table (4), and T2 is determined by the UE which is between a minimum value and the remaining packet delay budget. Minimum values are configured per priority which may be 1, 5, 10, or 20 slots. The Minimum value used depends on the priority of the sidelink transmission that trigger the resource selection procedure.

In Step 1, all resources are candidate resources before exclusion of resources is performed. The TX UE determines to exclude a candidate resource in the resource selection window if the TX UE has not performed sensing (due to half-duplex constraint) in a slot in which other TX UE that has performed transmission may reserve the candidate resource based on a resource reservation that may be used in the resource pool. The TX UE determines to exclude a candidate resource in the resource selection window if a measured SL RSRP of a resource that may cause collision with the candidate resource is higher than a threshold. The threshold is configured per priority pair (pi, pj), where pi is the priority indicated in the SCI scheduling the resource corresponding to the candidate resource, and pj is the priority of the sidelink transmission for which the resource selection procedure is triggered. A resource in the sensing window may cause collision with a candidate resource in the resource selection window if other TX UE that reserved the resource may also reserve:
part or all of the candidate resource based on the resource reservation period signalled in the SCI transmitted in the resource, or
part or all of a resource which may be reserved by the TX UE based on a resource reservation period assuming the candidate resource is selected.

After the exclusion is done, Step 2 is performed based on the remaining candidate resources. When selection resources in Step 2, for a resource pool configured with PSFCH, the gap between any two resources (a first resource and a second resource) should at least be equal to a+b, where a is a time gap between the end of the last symbol of the PSSCH transmission of the first resource and the start of the first symbol of the corresponding PSFCH reception determined by resource pool configuration, and b is a time required for PSFCH reception and processing plus sidelink retransmission preparation including multiplexing of necessary physical channels and any TX-RX/RX-TX switching time and is determined by UE implementation.

Considering a possible aperiodic transmission after a resource is selected in Mode 2, the TX UE may re-evaluate the selected resource to check whether it is still suitable for transmission shortly before transmitting in the selected resource. If the selected resources would not be part of the set of resources for selection at this time, new resources are selected from an updated resource selection window. In addition to the re-evaluation, pre-emption is also introduced such that a UE selects new resources even after it announces the resource reservation via SCI when it observes resource collision with a higher priority transmission from another UE. For re-evaluation and pre-emption procedures, the higher layer of the UE (e.g., MAC layer) may provide selected or reserved resources that are subject to re-evaluation or pre-emption, and the physical layer of the UE determines whether resource re-selection is needed, i.e., whether the resources subject to re-evaluation or pre-emption are still suitable for transmission. If it is determined that resource re-selection is needed, the UE re-selects resources in an updated resource selection window. The higher layer of the UE is not required to trigger re-evaluation or pre-emption procedures after slot m-T₃, where m is the earliest slot in which a resource is subject to re-evaluation or pre-emption and T₃ is equal to T_{proc,1}^{SL}, where T_{proc,1}^{SL} is defined in slots as in Table (4).

TABLE 4
T_{proc, 1}^{SL} depending on sub-carrier spacing:

| μ_{SL} | T_{proc, 1}^{SL} [slots] |
|---|---|
| 0 | 3 |
| 1 | 5 |
| 2 | 9 |
| 3 | 17 |

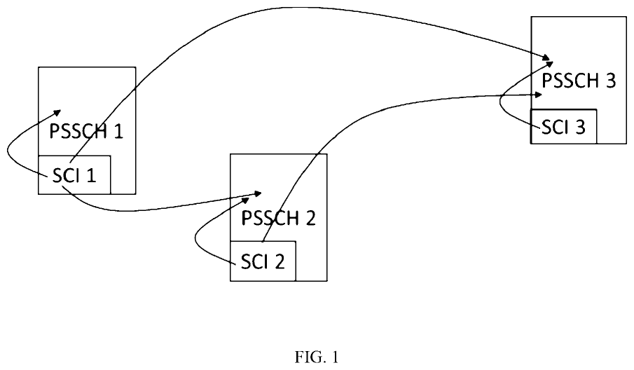

A SCI may be used to indicate up to three resources for a TB, including the resource in the same slot as the SCI. For example, FIG. 1 is a schematic diagram illustrating a SCI indicates three PSSCH for a TB. Referring to FIG. 1, SCI 1 transmitted together with PSSCH 1 is used to indicate initial transmission of a TB in PSSCH 1 and reserve resources for retransmission of the TB in PSSCH 2 and PSSCH 3. SCI 2 transmitted together with PSSCH 2 is used to indicate the first retransmission of the TB in PSSCH 2 and reserve resource for the second retransmission of the TB in PSSCH 3.

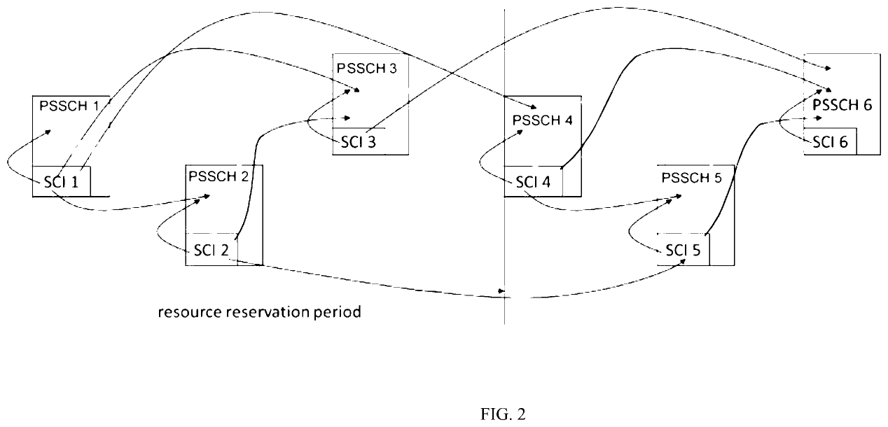

Besides indicating up to three resources for a TB, a SCI may also be used to indicate a resource for the next TB, by indicating a value in the resource reservation period field in the SCI. The value indicates one of the resource reservation periods in a list of resource reservation periods configured via sl-ResourceReservePeriodList-r16. For example, FIG. 2 is a schematic diagram illustrating a SCI indicates PSSCH for the next TB. Referring to FIG. 2, SCI 1 indicates PSSCH 4 is reserved for the next TB by indicating a resource reservation period that is not equal to 0 ms. PSSCH 1 and PSSCH 4 is separated in time by a duration equal to the indicated resource reservation period.

### Sidelink HARQ-ACK:

NR sidelink supports sidelink HARQ-ACK for sidelink unicast and groupcast services for improving reliability. Two sidelink HARQ-ACK operations are defined, ACK/NACK based feedback, and NACK only based feedback. When ACK/NACK based feedback is used, the sidelink HARQ-ACK procedure is similar to that of Uu for non-codeblock group feedback, i.e. the HARQ-ACK is transmitted based on the success or failure of the whole transport block. NACK-only HARQ-ACK is defined for groupcast to allow a larger number of RX UEs to share a single PSFCH resource by sending feedback only when a RX UE receives SCI but fails to decode the transport block. The transmission of NACK-only feedback can be restricted to RX UEs within a given radius to the TX UE, and any RX UE beyond the radius does not provide any NACK. This minimum range requirement of a service is provided together with the associated QOS parameters from service layers. For mode 1, sidelink HARQ-ACK information is reported to gNB via PUCCH to indicate whether additional retransmission resources are required or not. The slot for a PSFCH corresponding to a PSSCH is determined based on a minimum gap configured via sl-MinTimeGapPSFCH-r16 which may be 2 or 3 logical slots. For example, when the periodicity of PSFCH is 4 logical slots, if the PSSCH is transmitted in logical slot 0 and the minimum gap is 2 logical slots, then the PSFCH corresponding to the PSSCH is in logical slot 3, since logical slot 2 does not contain PSFCH. For another example, if the PSSCH is transmitted in logical slot 1 and the minimum gap is 2 logical slots, then the PSFCH corresponding to the PSSCH is in logical slot 3, since logical slot 3 satisfies the minimum gap and contains PSFCH.

A PUCCH for a TB is indicated by the DCI scheduling the TB to the TX UE for reporting the SL HARQ-ACK according to the PSFCH reception. The slot for the PUCCH is determined based on a PSFCH to PUCCH timing offset indicated by the DCI. The timing offset indicates the number of PUCCH slots between a PUCCH slot overlapping with the last PSFCH for the TB and the PUCCH for reporting SL HARQ-ACK.

### Congestion Control:

In sidelink communication, sidelink channel busy ratio (SL CBR) and sidelink channel occupancy ration (SL CR) are defined for congestion control.

SL CBR measured in slot n is defined as the portion of sub-channels in the resource pool whose Sidelink Received Signal Strength Indicator (SL RSSI) measured by the UE exceed a (pre-) configured threshold sensed over a CBR measurement window [n−a, n−1], wherein a is equal to 100 or 100·2^{μ} slots, according to higher layer parameter sl-TimeWindowSizeCBR. μ is the SCS configuration. SL RSSI is defined as the linear average of the total received power observed in the configured sub-channel in OFDM symbols of a slot configured for PSCCH and PSSCH, starting from the 2nd OFDM symbol.

SL CR evaluated at slot n is defined as the total number of sub-channels used for its transmissions in slots [n−a, n−1] and granted in slots [n, n+b] divided by the total number of configured sub-channels in the transmission pool over [n−a, n+b].

In Mode 2, up to 16 SL CBR ranges may be configured. Each of the one or more SL CBR ranges is configured with a corresponding SL CR limit. Each of the one or more SL CBR ranges is configured with corresponding values of transmission parameters, e.g., MCS, number of sub-channels, number of retransmissions, or transmission power, that may be used. The above configurations are configured per priority.

When a TX UE transmits PSSCH for a TB of a priority in slot n, if the SL CBR measured by a TX UE in slot n-N is within a SL CBR range for the priority, the TX UE needs to adjust the transmission parameters such that the SL CR measured by the TX UE in slot n-N does not exceed the SL CR limit for the priority corresponding to the SL CBR range for the priority. N is the congestion control processing time.

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”, which specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Any sentence, paragraph, (sub)-bullet, point, action, behavior, term, alternative, aspect, example, or claim described in the present disclosure may be combined logically, reasonably, and properly to form a specific method. Any sentence, paragraph, (sub)-bullet, point, action, behavior, term, alternative, aspect, example, or claim described in the present disclosure may be implemented independently and separately to form a specific method. Dependency, e.g., “based on”, “more specifically”, “in some implementations”, “in one alternative”, “in one example”, “in one aspect”, or etc., in the present disclosure is just one possible example in which would not restrict the specific method. One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc. According to any sentence, paragraph, (sub)-bullet, point, action, behavior, term, alternative, aspect, example, implementation, or claim described in the present disclosure, “X/Y” may include the meaning of “X or Y”. According to any sentence, paragraph, (sub)-bullet, point, action, behavior, term, alternative, aspect, example, implementation, or claim described in the present disclosure, “X/Y” may also include the meaning of “X and Y”. According to any sentence, paragraph, (sub)-bullet, point, action, behavior, term, alternative, aspect, example, implementation, or claim described in the present disclosure, “X/Y” may also include the meaning of “X and/or Y”.

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

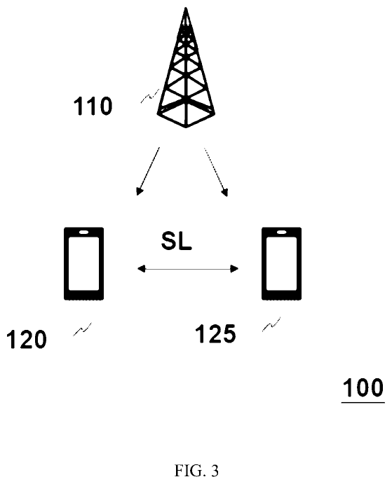

FIG. 3 is a schematic diagram that illustrates a radio communication network architecture 100 according to an exemplary embodiment of the present disclosure. Referring to FIG. 3, a radio communication network architecture 100 (e.g., a Long Term Evolution (LTE) system, an LTE-Advanced (LTE-A) system, an LTE-Advanced Pro system, or a 5G NR Radio Access Network (RAN)) typically includes at least one base station 110, at least one UE 120, and one or more optional network elements that provide connection towards a network. The UE 120 communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations 110.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present disclosure should not be limited to the above-mentioned protocols.

A base station may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The base station may be operable to provide radio coverage to a specific geographical area using a plurality of cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmission). The BS may communicate with one or more UEs in the radio communication system through the plurality of cells.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the MAC entity is associated with the MCG or the SCG. Otherwise, the term Special Cell may refer to the PCell. A Special Cell may support a Physical Uplink Control Channel (PUCCH) transmission and contention-based Random Access (CBRA), and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

There are some technical problems:

### Channel Access Procedures:

For sidelink communication, a TX UE directly communicates with a RX UE. How to determine the LBT category for the TX UE and the RX UE needs to be resolved.

For Cat 4 LBT, CAPC for sidelink transmission needs to be defined. The mechanism of contention window size adjustment also needs to be resolved.

To avoid the losing the channel in an acquired COT, how to enable CP extension for sidelink transmissions needs to be resolved.

### Resource Allocation:

In an unlicensed band with occupied channel bandwidth (OCB) requirements and power spectral density (PSD) limitations, interlace based resource allocation needs to be used. How to allocate subchannels with interlaces needs to be resolved.

To provide more slots for sidelink transmissions, methods for utilizing semi-static flexible symbols may be introduced.

### Reliability in Unlicensed Band:

In an unlicensed band, a sidelink transmission may not be performed if the LBT prior to the sidelink transmission is not successful. To provide more resources that may be used by a TX UE, method for reselection of resources in response to LBT failure is needed. To provide more resources that may be used by a TX UE, method for providing more PSFCH occasions is needed.

### Congestion Control:

In an unlicensed band, the measured CBR may be affected by signals from other systems. That is, the measured CBR may not accurately reflect the load of sidelink transmissions in the resource pool.

Some proposals are provided for the above technical problems.

### Channel Access Procedures:

In one implementation, for Mode 1, to enhance the probability of a scheduling DCI being successfully received by a TX UE, the scheduling DCI is transmitted in a first cell in a licensed band to schedule one or more PSSCH/PSCCH transmissions in a second cell in an unlicensed band.

In one implementation, for a Mode 1 UE, the gNB indicates the channel access procedure type (i.e., LBT category) for a PSSCH/PSCCH in a field of the scheduling DCI. In one implementation, if the scheduling DCI schedules more than one PSSCH/PSCCH, the channel access procedure type applied for each PSSCH/PSCCH is indicated in the scheduling DCI. In one alternative, if the scheduling DCI schedules more than one PSSCH/PSCCH, only the channel access procedure type applied for the earliest PSSCH/PSCCH is indicated in the scheduling DCI.

In one implementation, Type 2 channel access procedure may be indicated to a TX UE if the gNB acquired a COT that contains the PSSCH/PSCCH. Specifically, Type 2A may be indicated if the gap between the end of a DL/UL/SL transmission burst prior to the PSSCH/PSCCH and the start of the PSSCH/PSCCH is at least 25 μs. Type 2B may be indicated if the gap between the end of a DL/UL/SL transmission burst prior to the PSSCH/PSCCH and the start of the PSSCH/PSCCH is equal to 16 μs. Type 2C may be indicated if the gap between the end of a DL/UL/SL transmission burst prior to the PSSCH/PSCCH and the start of the PSSCH/PSCCH is up to 16 ps. The gNB may also indicate the CP extension applied for the PSSCH/PSCCH via the scheduling DCI such that the gap of specific duration described above may be created. The TX UE may also determine the CP extension implicitly based on the indicated channel access priority type. This may be achieved if the gNB ensures no UL transmission occurs before the PSSCH/PSCCH as the frame timing for UL transmissions is different from that of SL transmissions. Since the CP extension is used to fill the last guard symbol in the previous slot, the length of the CP extension may be implicitly determined as the length of one symbol minus the 25 μs or one symbol minus 16 μs which is based on the SCS and the indicated channel access procedure type. In one alternative, the CP extension length may be indicated explicitly. For example, a list of CP extension lengths may be pre-configured or pre-defined. The gNB indicates an index in the scheduling DCI, and the UE applies the CP extension length corresponding to the indicated index. The configuration of CP extension may be configured as part of the resource pool configurations or as part of the SL BWP configurations.

In one implementation, when Type 1 channel access procedure is indicated to a TX UE for a PSSCH/PSCCH in slot n, the gNB may not need to indicate the channel access procedure type for another PSSCH/PSCCH after slot n. In one implementation, the TX UE may implicitly determine Type 1 channel access procedure is used for the other PSSCH/PSCCH after slot n. In one alternative, when Type 1 channel access procedure is indicated to a TX UE for a PSSCH/PSCCH in slot n, if the DCI scheduling the PSSCH/PSCCH also schedules a second PSSCH/PSCCH in slot n+1 and PSFCH is not present in slot n, the TX UE may use Type 2A, Type 2B, or Type 2C channel access procedure for the second PSSCH/PSCCH. In one implementation, Type 2A channel access procedure may be used if CP extension is applied to the first symbol of the second PSSCH/PSCCH such that the gap between the end of the PSSCH/PSCCH and the start of the second PSSCH/PSCCH is equal to 25 μs. In one implementation, Type 2B channel access procedure may be used if CP extension is applied to the first symbol of the second PSSCH/PSCCH such that the gap between the end of the PSSCH/PSCCH and the start of the second PSSCH/PSCCH is at equal 16/s. In one implementation, Type 2C channel access procedure may be used if CP extension is applied to the first symbol of the second PSSCH/PSCCH such that the gap between the end of the PSSCH/PSCCH and the start of the second PSSCH/PSCCH is up to 16 ps. The CP extension is used to create a gap of specific durations in the guard symbol of slot n. Therefore, when the duration of the guard symbol is smaller than 16 As, e.g., when SCS of the SL BWP is 120 kHz, no CP extension is needed to apply Type C channel access procedure for the second PSSCH/PSCCH. In one alternative, the TX UE may determine Type 2A channel access procedure is used for the other PSSCH/PSCCH within the COT acquired by the TX UE after slot n, if the channel is sensed by the TX UE to be continuously idle after transmitting the PSSCH/PSCCH in slot n. In one implementation of the alternative, the channel may be determined as continuously idle regardless of the sensing results in the symbols containing PSFCH in the resource pool.

In one alternative, the gNB indicates the remaining COT acquired by the gNB in a field of the scheduling DCI. In one alternative, the gNB indicates the remaining COT acquired by the gNB via a DCI format 2_0, wherein the DCI format 2_0 is transmitted in a Type 3 CSS in a cell which may be the same cell as the scheduled PSSCH/PSCCH or may be the same cell as the scheduling DCI. The TX UE determines to apply Type 1 channel access procedure for a PSSCH/PSCCH if the PSSCH/PSCCH is not within the remaining COT acquired by the gNB. The TX UE determines to apply Type 2A channel access procedure for a PSSCH/PSCCH if the PSSCH/PSCCH is within the remaining COT acquired by the gNB. Otherwise, Type 1 channel access procedure is used for the PSSCH/PSCCH. The alternative may also be applicable for SL CG.

In one implementation, for a PUCCH transmitted by a Mode 1 TX UE, the gNB may indicate the channel access procedure type in the scheduling DCI. In one alternative, the TX UE determines the channel access procedure type based on the remaining COT signalled by the gNB. If the PUCCH is within the remaining COT, Type 2A channel access procedure type is applied for the PUCCH. Otherwise, Type 1 channel access procedure type is applied for the PUCCH.

In one implementation, for a Mode 2 UE, Type 1 channel access procedure is applied for a PSSCH/PSCCH in slot n. If the UE reserved a second PSSCH/PSCCH in slot n+1 and PSFCH is not present in slot n, the TX UE may use Type 2A, Type 2B, or Type 2C channel access procedure for the second PSSCH/PSCCH. Similar to the method for Mode 1 UEs, CP extension may be applied to the first symbol of the second PSSCH/PSCCH to create a gap with specific duration between the end of the PSSCH/PSCCH and the start of the second PSSCH/PSCCH.

In one implementation, whether the field(s) for indicating channel access procedure type, channel access priority class, and CP extension are present in a DCI may be configured via RRC signaling. Alternatively, the field(s) may always be present when the scheduled cell is in an unlicensed band. The information may be jointly indicated by one field.

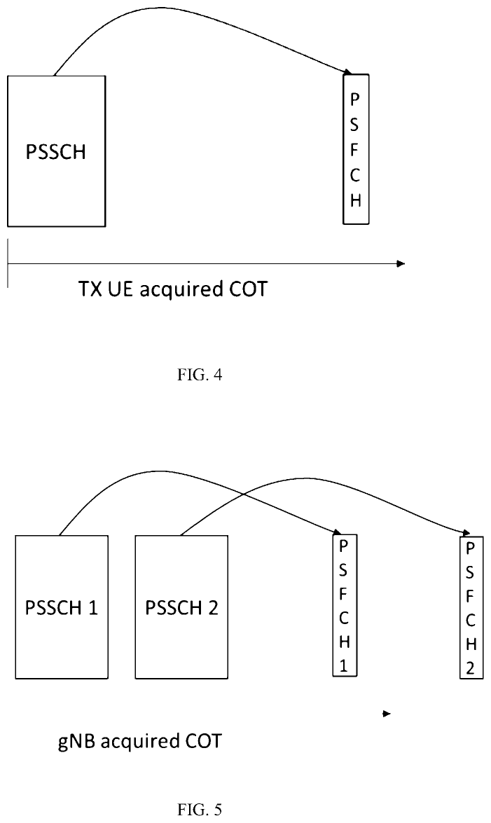

In one implementation, for a RX UE transmitting a PSFCH in slot m corresponding to a PSSCH/PSCCH transmitted by a Mode 1 TX UE in slot n, the gNB indicates the channel access procedure type for the PSFCH in the DCI scheduling the PSSCH/PSCCH. The gNB may also indicate the CP extension for the PSFCH in the DCI scheduling the PSSCH/PSCCH. The TX UE sets the indication of the channel access procedure type for the PSFCH in the SCI transmitted in PSCCH in slot n. In one implementation, if the gNB indicates Type 1 channel access procedure is applied for the PSSCH/PSCCH in slot n, the gNB may not need to indicate the channel access procedure type for the PSFCH in slot m, e.g., when the PSFCH in slot m is within a COT acquired by the TX UE. In one implemention, when the gNB does not indicate the channel access procedure type for the PSFCH in slot m or when the TX UE determines the PSFCH in slot m would be in the COT acquired by the TX UE, the TX UE sets the indication of Type 2A channel access procedure type for the PSFCH in the SCI transmitted in PSCCH in slot n, as shown in FIG. 4 which illustrates TX UE shares a COT with RX UE.

In one implementation, Type 2B channel access procedure type for the PSFCH or Type 2C channel access procedure type for the PSFCH may also be indicated in the SCI when CP extension is applied to the first symbol of the PSFCH such that the gap between the end of a PSSCH/PSCCH in slot m and the start of the PSFCH in slot m is equal to 16 μs or up to 16 μs, respectively. In other words, the length of the CP extension may be implicitly determined by the RX UE based on the indicated channel access procedure type. In one implementation, the TX UE may also indicate the CP extension for the PSFCH in the SCI transmitted in PSCCH in slot n. In one implementation, if the gNB indicates Type 2A/2B/2C channel access procedure is applied for the PSSCH/PSCCH in slot n, the gNB may also indicate Type 2A/2B/2C channel access procedure is applied for the PSFCH in slot m if both PSSCH/PSCCH and PSFCH are within a COT initiated by the gNB. For an example as shown in FIG. 5 which illustrates a gNB shares a COT with TX UE and RX UE, the gNB shares a COT with PSSCH 1, PSSCH 2 and PSFCH 1 but not with PSFCH 2. The CP extension for the PSFCH may also be indicated by the gNB in the DCI scheduling the PSSCH/PSCCH and indicated in the SCI transmitted by the TX UE, or the RX UE may determine the CP extension based on the indicated channel access procedure type.

In one alternative, the gNB indicates the remaining COT acquired by the gNB in a field of the scheduling DCI or in a DCI format 2_0 to the TX UE as described above. The TX UE sets the indication in the SCI which indicates the channel access procedure type for the PSFCH transmitted by the RX UE based on the remaining COT acquired by the gNB. The TX UE sets the channel access procedure type for the PSFCH as Type 2A channel access procedure if the PSFCH is within the remaining COT acquired by the gNB. Otherwise, the TX UE sets the channel access procedure type for the PSFCH as Type 1 channel access procedure.

In one implementation, for a RX UE transmitting a PSFCH in slot m corresponding to a PSSCH/PSCCH transmitted by a Mode 2 TX UE in slot n, the TX UE sets the indication of the channel access procedure type for the PSFCH in the SCI transmitted in PSCCH in slot n. When the TX UE determines the PSFCH in slot m would be in the COT acquired by the TX UE, the TX UE sets the indication of Type 2A channel access procedure type for the PSFCH in the SCI transmitted in PSCCH in slot n. In one implementation, the TX UE may also indicate the CP extension applied for the PSFCH via the SCI such that the gap of specific duration may be created. Type 2B channel access procedure type for the PSFCH or Type 2C channel access procedure type for the PSFCH may also be indicated in the SCI when CP extension is applied to the first symbol of the PSFCH such that the gap between the end of a PSSCH/PSCCH in slot m and the start of the PSFCH in slot m is equal to 16 μs or up to 16 μs, respectively. In one implementation, the RX UE may also determine the CP extension implicitly based on the indicated channel access priority type. Since the CP extension is used to fill the guard symbol before the PSFCH, the length of the CP extension may be implicitly determined as the length of one symbol minus the 25 μs or one symbol minus 16 As which is based on the SCS and the indicated channel access procedure type. In one alternative, the CP extension length may be indicated explicitly. For example, a list of CP extension lengths may be pre-configured or pre-defined. In one implementation, the TX UE indicates an index in the SCI, and the RX UE applies the CP extension length corresponding to the indicated index. The configuration of CP extension may be configured as part of the resource pool configurations or as part of the SL BWP configurations.

In one alternative, the TX UE indicates the remaining COT acquired by the TX UE in the SCI transmitted in PSCCH in slot n. The remaining COT information may be included in the 1^{st}-stage SCI or in the 2^{nd}-stage SCI. In one implementation, the RX UE determines to apply Type 2A channel access procedure for the PSFCH in slot m if the PSFCH is within the remaining COT acquired by the TX UE. Otherwise, Type 1 channel access procedure is used for the PSFCH. There may be multiple RX UEs sharing a COT acquired by the TX UE if the PSSCH is for sidelink groupcast. To indicate the remaining COT, a list of pre-configured or pre-defined values may be configured per resource pool or per SL BWP, and the SCI indicates a value from the list by an index. Alternatively, the remaining COT may be implicitly indicated by a CAPC indicated in the SCI. For example, the remaining COT may be the T_{ulmcot,p} as in Table (3) corresponding to CAPC p. Alternatively, the remaining COT may be implicitly determined by the RX UE based on the service of the traffic carried by the PSSCH.

In one implementation, when a TX UE is a RX UE of a second TX UE, i.e., the TX UE transmits a PSSCH/PSCCH in a slot and receives a second PSSCH/PSCCH in a second slot and transmits a PSFCH corresponding to the second PSSCH/PSCCH in a third slot, if the TX UE initiated a COT for transmitting the PSSCH/PSCCH and if the third slot is within the COT, the TX UE may use Type 2A, Type 2B, or Type 2C channel access procedure for the second PSSCH/PSCCH if the TX UE also transmits a third PSSCH/PSCCH in the third slot and if the CAPC associated with the PSSCH has lower priority (i.e., with higher CAPC value) than the CAPC associated with the second PSSCH. In one implementation, type 2A channel access procedure may be used if CP extension is applied to the first symbol of the PSFCH such that the gap between the end of the third PSSCH/PSCCH and the start of the PSFCH is equal to 25 μs. In one implementation, type 2B channel access procedure may be used if CP extension is applied to the first symbol of the PSFCH such that the gap between the end of the third PSSCH/PSCCH and the start of the PSFCH is at equal 16 μs. In one implementation, type 2C channel access procedure may be used if CP extension is applied to the first symbol of the PSFCH such that the gap between the end of the third PSSCH/PSCCH and the start of the PSFCH is up to 16 μs. The CP extension is used to create a gap of specific durations in the guard symbol before the PSFCH. Therefore, when the duration of the guard symbol is smaller than 16 as, e.g., when SCS of the SL BWP is 120 kHz, no CP extension is needed to apply Type 2C channel access procedure for the PSFCH.

In one implementation, when a UE is a RX UE of a first TX UE and a RX UE of a second TX UE, i.e., the RX UE receives a first PSSCH/PSCCH in a first slot from the first TX UE and receives a second PSSCH/PSCCH in a second slot from the second TX UE and transmits a first PSFCH corresponding to the first PSSCH/PSCCH in a third slot and transmits a second PSFCH corresponding to the second PSSCH/PSCCH in the third slot, if the RX UE determines that the first PSFCH may be transmitted by sharing a COT initiated by the first TX UE and the second PSFCH may not be transmitted by sharing a COT initiated by the second TX UE, the RX UE may transmit both the first PSFCH and the second PSFCH by sharing the COT initiated by the first TX UE if the CAPC associated with the first PSSCH/PSCCH has lower priority (i.e., with higher CAPC value) than the CAPC associated with the second PSSCH/PSCCH. In one alternative, the RX UE determines to use Type 1 channel access procedure for transmitting the first PSFCH and the second PSFCH if one of the channel access procedure types determined for the first PSFCH and the second PSFCH is Type 1 channel access procedure.

In one implementation, channel access priority class (CAPC) is configured per sidelink logical channel. For a Mode 1 TX UE, the gNB indicates the CAPC associated with the scheduled PSSCH/PSCCH when Type 1 channel access procedure is used for the PSSCH/PSCCH. For a SL CG (e.g., either Type 1/Type 2 sidelink configured grants), the CAPC associated with the configured PSSCH/PSCCH is determined by the TX UE as the CAPC with lowest priority (with highest CAPC value) of CAPCs configured for the logical channels multiplexed in the MAC PDU transmitted in the PSSCH when Type 1 channel access procedure is used for the PSSCH/PSCCH. For a Mode 2 TX UE, the CAPC associated with the configured PSSCH/PSCCH is determined by the TX UE as the CAPC with lowest priority (with highest CAPC value) of CAPCs configured for the logical channels multiplexed in the MAC PDU transmitted in the PSSCH when Type 1 channel access procedure is used for the PSSCH/PSCCH.

In one implementation, for transmission of a PSFCH, CAPC 1 is applied if Type 1 channel access procedure is used for the PSFCH.

In one implementation, if a TX UE transmits transmissions using Type 1 channel access procedures that are associated with channel access priority class p, the UE may adjust the contention window value CWₚ before a Type 1 channel access procedure starts. For the first time a Type 1 channel access procedure is performed on a channel, the TX UE sets CWₚ to CWₚₘᵢₙ. For a Type 1 channel access procedure that is not performed for the first time on the channel, the following is applied.

In one implementation, when the Type 1 channel access procedure is used for a PSSCH/PSCCH, and when PSFCH is not configured for the resource pool, if the PSSCH/PSCCH is for an initial transmission for a TB, or if the PSSCH/PSCCH is for a retransmission for the TB and if the PSSCH/PSCCH is within a duration from the initial transmission of the TB, the TX UE maintains the CWₚ. Otherwise, if the PSSCH/PSCCH is for a retransmission for the TB and if the PSSCH/PSCCH is not within a duration from the initial transmission of the TB, the TX UE sets CWₚ to the next higher value in the list of the allowed CWₚ values.

In one implementation, when the Type 1 channel access procedure is used for a PSSCH/PSCCH, and when PSFCH is configured for the resource pool, if SL HARQ-ACK is available for a PSSCH in an earliest COT after the last time CWₚ is updated, the UE determines whether to adjust CWₚ based on the PSSCH. In one implementation, the PSSCH may be determined as the earliest PSSCH or earliest PSSCHs in the same slot in the COT. The TX UE sets CWₚ to the next higher value in the list of the allowed CWₚ values for every p if NACK(s) are received for the PSSCH(s). Otherwise, if at least one ACK is received for the PSSCH(s), the TX UE sets CWₚ to CWₚₘᵢₙ for every p. If NACK-only based feedback is used for the PSSCH(s), the TX UE sets CWₚ to the next higher value in the list of the allowed CWₚ values for every p if at least one NACK is received for the PSSCH. Otherwise, if no NACK is received for the PSSCH(s), the TX UE maintains the CWₚ for every p. When ACK/NACK feedback and NACK-only feedback are used for the PSSCH(s), the UE may determine to adjust CWₚ based on only the ACK/NACK feedback.

For a Mode 1 TX UE, if the Type 1 channel access procedure is used for a PSSCH/PSCCH scheduled by a DCI with a toggled NDI value, the TX UE sets CWₚ to CW_{p,min} for every p.

In one implementation, when the Type 1 channel access procedure is used for a PSFCH, the TX UE uses the CWₚ used for the last transmission on the channel. The UE may use channel access priority class p−1.

If CWₚ=CW_{p,max} is consecutively used for a number of times for a CAPC p, the TX UE sets CWₚ to CW_{p,min} only for the CAPC p.

### Resource Allocation:

In one implementation, a subchannel contains two or more interlaces, and one or more interlaces within the subchannel is used for PSCCH, the remaining resources in the subchannels are used for PSSCH. The number of interlaces for a PSCCH may be configured explicitly, or the number of interlaces for a PSCCH may be determined based on a configured number of PRBs for a PSCCH. For example, the number of interlaces for a PSCCH may be determined as a smallest number that includes a number of PRBs equal to or larger than the number of PRBs for a PSCCH. In one implementation, the indexes of the interlaces that may be used for PSCCHs is predefined based on the size of a subchannel and the size of a PSCCH. For example, when a subchannel is with two interlaces and a PSCCH is with one interlace, the first subchannel comprises interlace 0 and interlace 1, the second subchannel comprises interlace 2 and interlace 3, and so on. The indexes of the interlaces that may be used for PSCCHs is 0, 2, . . . , and so on.

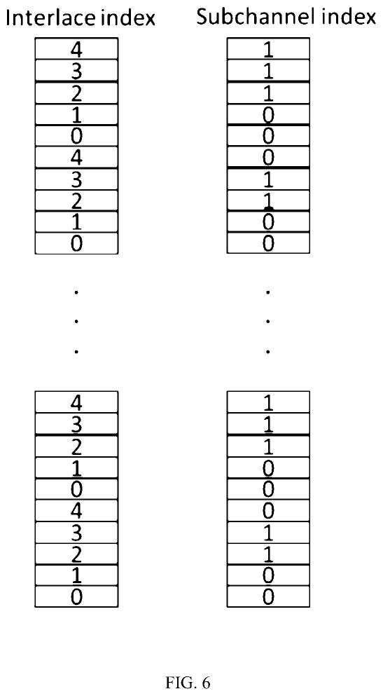

For example, when 30 kHz SCS is used for PSSCH/PSCCH, there are 5 interlaces each with 10 or 11 PRBs within 20 MHz. Interlace 0 and interlace 1 belongs to subchannel 0, and interlace 0 may be used for PSCCH. Interlace 2 and interlace 3 belongs to subchannel 1, and interlace 2 may be used for PSCCH. In this case, interlace 4 cannot be used for another subchannel. To better utilize the resource, the PRBs in interlace 4 may be equally divided to be used for subchannel 0 and subchannel 1, as shown in FIG. 6. Configuration of the subchannels is included as part of the resource pool configurations. Configuration of the interlace, e.g. total number of interlaces, may be configured as part of the resource pool configurations or as part of the SL BWP configurations.

In one implementation, for ACK/NACK based feedback, only non-interlace based resource allocation is used for PSFCH, since the number of interlaces is not enough to multiplex PSFCH for multiple RX UEs. In one implementation, for NACK-only based feedback, whether interlace based resource allocation is used for PSFCH may be configured per resource pool since multiple RX UEs may share the same resource.

In one implementation, when a synchronization source UE sets the content of sl-TDD-Config, the UE should set the number of UL slots in sl-TDD-Config based on the semi-static UL symbols configured by tdd-UL-DL-ConfigurationCommon, and based on the semi-static flexible symbols configured by tdd-UL-DL-ConfigurationCommon under some conditions. That is, semi-static flexible symbols are considered as semi-static UL symbols when determining the number of UL slots to be indicated in sl-TDD-Config. A condition may be that if the UE is in RRC_CONNECTED and not configured to monitor DCI format 2_0. The reason is that the gNB does not intend to dynamically use the semi-static flexible symbols as for DL transmissions if the UE is not configured to monitor DCI format 2_0. On the other hand, if the UE is in RRC_CONNECTED and configured to monitor DCI format 2_0, the UE sets the number of UL slots in sl-TDD-Config based on only the semi-static UL symbols configured by tdd-UL-DL-ConfigurationCommon. For a UE not in RRC_CONNECTED, the UE sets the number of UL slots in sl-TDD-Config based on only the semi-static UL symbols configured by tdd-UL-DL-ConfigurationCommon, since the gNB does not know whether the semi-static flexible symbols may be used for SL transmissions by the UE and other UEs selected the UE as a SyncRef UE.

### Reliability in Unlicensed Band:

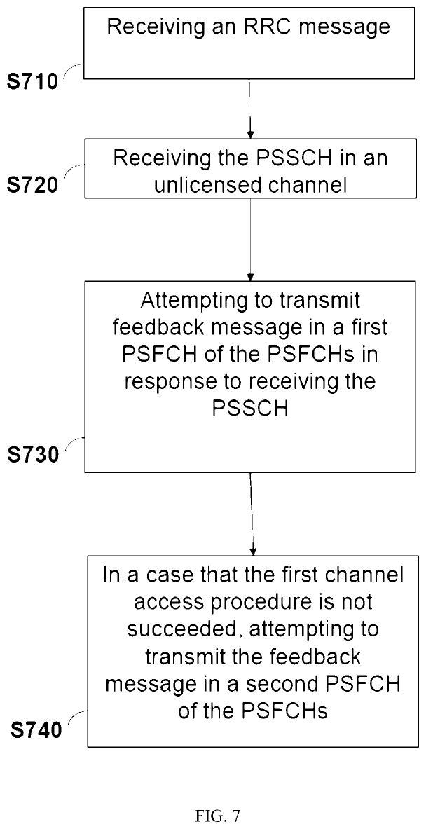

FIG. 7 is a flow chart of a method adapted for a UE according to an exemplary embodiment of the present disclosure. Referring to FIG. 7, note that the order of the steps in this Figure may be changed according to the actual requirements.

Step S710: a UE receives an RRC message. The RRC message includes a minimum gap between the earliest slot of multiple logical slots of PSFCHs and a logical slot of a PSSCH. The logical slots of PSFCHs are assigned for the PSSCH. Compared with the conventional allocation, more than one logical slot of PSFCH would be allocated for one PSSCH.

Step S720: the UE receives the PSSCH in an unlicensed channel.

Step S730: the UE attempts to transmit a feedback message in a first PSFCH of the PSFCHs in response to receiving the PSSCH. Attempting to transmit the feedback message in the first PSFCH further includes the UE performing a first channel access procedure in the unlicensed channel before the first PSFCH. The first channel access procedure may be, for example, Type1, Type 2A, Type 2B, or Type 2C channel access procedure.

Step S740: in a case that the first channel access procedure is not succeeded, the UE attempts to transmit the feedback message in a second PSFCH of the PSFCHs. Attempting to transmit the feedback message in the second PSFCH includes the UE performing a second channel access procedure in the unlicensed channel before the second PSFCH. The second channel access procedure may be, for example, Type1, Type 2A, Type 2B, or Type 2C channel access procedure.

In one implementation, a UE may receive a sidelink control information (SCI). The SCI may include a feedback type of the PSFCHs, and the feedback type indicated as negative acknowledge (NACK) only in response to the PSFCHs being transmitted by sharing a channel occupancy time (COT). For example, to avoid NACK-only feedback being interpreted as ACK when RX UEs fail LBT for the PSFCH, feedback type is indicated as NACK-only feedback by the TX UE in the scheduling SCI when the PSFCH is transmitted by sharing a COT initiated by the TX UE or by gNB.

In one implementation, the RRC message may further include a periodicity of the PSFCHs, the periodicity of the PSFCH indicates N logical slots, and the number of the logical slots of the PSFCHs is N−1. In some implementations, the RRC message may further include a number indication of the number of the logical slots of the PSFCHs.

In one implementation, the RRC message may further include a number indication of the number of the logical slots of the PSFCHs.

In one implementation, an overlap between the logical slots of PSFCHs for the PSSCH is absent. That is, there is no overlap between multiple logical slots of PSFCHs.

In one implementation, to provide more opportunities for SL HARQ-ACK transmission in case when LBT fails, the slot for a PSFCH corresponding to a PSSCH is determined as the earliest slot in which a PSFCH is present and the slot is a number of logical slots (i.e., a minimum gap configured via sl-MinTimeGapPSFCH-r16 carried by RRC message) offset from the slot for the PSSCH, wherein the slots in which PSFCHs are present is determined based on the periodicity configured for PSFCHs via sl-PSFCH-Period-r16 carried by RRC message. Additional slots are used for PSFCHs for the PSSCH. When the slot for the PSFCH corresponding to the PSSCH is in logical slot n, and sl-PSFCH-Period-r16 indicates a periodicity of N logical slots, PSFCHs are also present in additional slots which may be one or more of the slots from logical slot n+1, . . . , logical slot n+N−1.

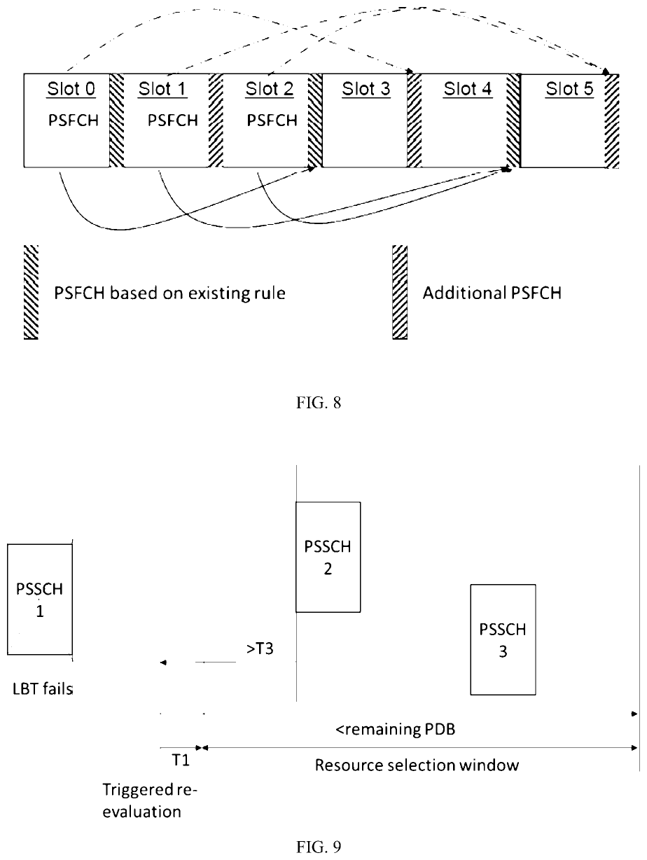

For example, FIG. 8 is a schematic diagram illustrating additional slots used for PSFCHs according to an exemplary embodiment of the present disclosure. Referring to FIG. 8, when the periodicity of PSFCH is 2 logical slots, if the PSSCH is transmitted in logical slot 0 and the minimum gap is 2 logical slots, then the PSFCH corresponding to the PSSCH is in logical slot 2, and additional PSFCH in logical slot 3 may be used for the SL HARQ-ACK for the PSFCH when LBT fails for the PSFCH in logical slot 2, as shown in FIG. 8. Whether there are additional PSFCH is configured per resource pool.

In one implementation, a UE may apply a first channel access procedure type on the PSSCH or a PSCCH in slot n, and apply a second channel access procedure type on the PSSCH or a PSCCH in slot n+1 in response to one of the PSFCHs not present in the slot n. For example, the first channel access procedure type is Type 1, and the second channel access procedure type is Type 2A, Type 2B, or Type 2C.

In one implementation, a UE may receive an SCI indicating a channel access procedure type of one of the PSFCHs, acquire a COT, and apply the channel access procedure type on the one of the PSFCHs within the COT.

In one implementation, to provide more opportunities for PSSCH/PSCCH transmissions for a TB in case when LBT fails, re-evaluation procedure may be triggered and resource reselection may be performed in a period if a PSSCH/PSCCH has not been transmitted in the period and if the selected resources for the PSSCH/PSCCH in the period has not been signaled by SCI transmitted in previous periods. For example, FIG. 9 is a schematic diagram illustrating re-evaluation when LBT fails according to an exemplary embodiment of the present disclosure. Referring to FIG. 9, when the Mode 2 TX UE selected 3 resources for PSSCH/PSCCH transmissions (e.g., PSSCH1, PSSCH2, and PSSCH3) for a TB, if the LBT fails for the initial transmission of the TB in the first PSCCH/PSCCH transmission (e.g., PSSCH 1), the TX UE may perform re-evaluation procedure before slot m-T3 in a resource selection window, where slot m is the slot in which the second PSCCH/PSCCH transmission is selected for the TB, and T₃ is equal to T_{proc,1}^{SL}. The resource selection window is from slot n+T1 to slot n+T2, where n is the slot in which the re-evaluation procedure is triggered, T1 is equal to T_{proc,1}^{SL}, and T2 is determined by the UE which is between a minimum value and the remaining packet delay budget.

In one implementation, the TX UE selects a resource for PSSCH/PSCCH in the resource selection window in order to replace the first PSSCH/PSCCH that was not transmitted. The TX UE may also reselect up to two resources for PSSCH/PSCCH in the resource selection window when it is determined that the resources for the selected second PSSCH/PSCCH and the selected third PSSCH/PSCCH are not part of the candidate resources after Step 1 of the re-evaluation procedure, i.e., after the candidate resources for resource selection are determined. To enable re-evaluation procedure to be triggered when LBT fails, the TX UE should ensure a minimum time gap of T3 between any two selected resources for PSSCH/PSCCH. It is noted that re-evaluation procedure may be triggered before the third resource when LBT also fails for the second resource.

In one implementation, when a PSSCH/PSCCH has not been transmitted in a period and if the resources for the PSSCH/PSCCH in the period has been signaled by SCI transmitted in previous periods, re-evaluation procedure may be triggered and resource reselection may be performed as described above. In one implementation, the UE may select a fourth resource for PSSCH/PSCCH to provide the desired number of retransmissions for the TB. The UE may indicate that the same fourth resource is reserved (by setting a non-zero value of resource reservation period) in the next period in the SCI transmitted in the fourth PSCCH. In one implementation, if the UE reserves the fourth resource in the next period, the UE does not transmit PSSCH/PSCCH in the first resource in the next period. In an alternative, if the UE does not reserve the fourth resource in the next period, the UE may use the first resource in the next period and not use the fourth resource in the next period. The UE may determine the resource the fourth resource in the next period if the UE detects a PSCCH in the slot for the first resource (for which the LBT fails), if the SCI in the PSCCH indicates the same resource reservation period as the resource reservation period selected by the UE, and if the measured SL RSRP of the PSCCH is above a threshold. To achieve this, the re-evaluation procedure may be triggered after slot a+T_{proc,0}^{SL}, where T_{proc,0}^{SL} is the processing time to complete sensing and slot a is the slot for the first PSSCH/PSCCH, so that the sensing result of slot a can be acquired.

In one alternative, if the resources for the PSSCH/PSCCH in the period has been signaled by SCI transmitted in previous periods, re-evaluation procedure is triggered in the next period. That is, the re-evaluation procedure is not triggered for the current TB, and the current TB is transmitted in the remaining reserved resources after LBT fails for the first resource, i.e., transmitted in the second resource and the third resource. More specifically, re-evaluation procedure is triggered before slot b−T3, where slot b is the slot for the first resource in the next period. In other words, the slot for the first resource in the current period is slot b-rsvp, where rsvp is the reservation period signalled by SCI transmitted in previous periods. The UE re-evaluates the resources in a resource selection window starting from slot n′+T1 to slot n′+T2, and reselects the resources in the resource selection window if the reserved resource(s) are not part of the candidate resources, where n′ is the slot in which the re-evaluation procedure is triggered.

### Congestion Control:

In one implementation, to reflect the load of sidelink transmissions in a resource pool in an unlicensed band, a measured SL RSSI in a slot is used for CBR measurement if the UE detects a PSCCH in the slot.

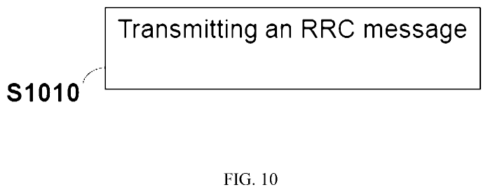

FIG. 10 is a flow chart of a method adapted for a base station according to an exemplary embodiment of the present disclosure. Referring to FIG. 10, note that the order of the steps in this Figure may be changed according to the actual requirements.

Step S1010: a base station transmits an RRC message. The RRC message includes a minimum gap between the earliest slot of multiple logical slots of PSFCHs and a logical slot of a PSSCH. The logical slots of PSFCHs are assigned for the PSSCH.

In one implementation, the RRC message may further include a periodicity of the PSFCHs, the periodicity of the PSFCH indicates N logical slots, and the number of the logical slots of the PSFCHs is N−1. In some implementations, the RRC message may further include a number indication of the number of the logical slots of the PSFCHs.

In one implementation, the RRC message may further include a number indication of the number of the logical slots of the PSFCHs.

In exemplary embodiments of the present disclosure, multiple implementations for dealing with sidelink operation in unlicensed bands are provided. The implementations may be featured with:
Channel access procedures;
Resource allocation;
Reliability in unlicensed band;
Congestion control.

It is noted that the proposed mechanisms may be applicable to NR-RAT and E-UTRA (e.g., the serving BS of the SL_Tx UE/SL-Rx UE may be a gNB/eNB or a E-UTRA cell/NR Cell respectively).

In some additional implementations, the proposed information included in a DCI or a SCI may be applicable to E-UTRA DCI or a E-UTRA SCI.

In some other implementations, the proposed mechanisms/parameters may be pre-configured via sidelink pre-configuration.

In some implementations, the proposed mechanisms may also be applicable to LTE sidelink communication service/LTE sidelink discovery service/LTE V2X sidelink communication service/ProSe (communication/discovery) services/(Layer-2/Layer-3) (NR/LTE) Relay services.

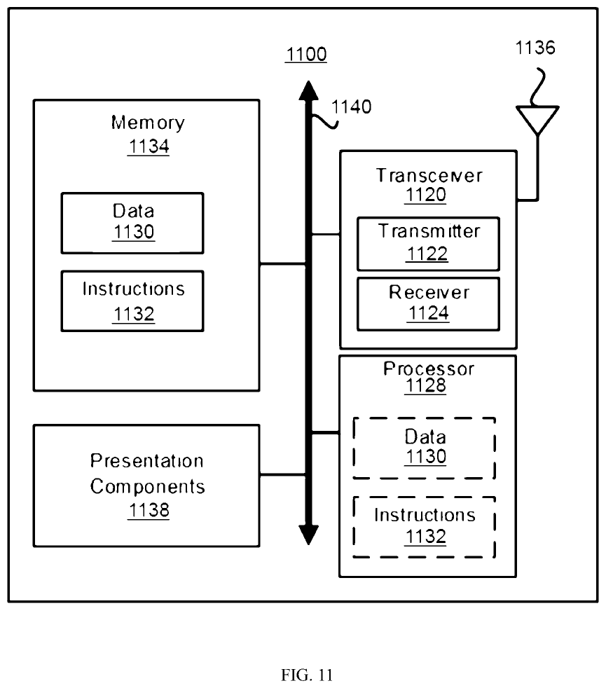

FIG. 11 illustrates a block diagram of a node for wireless communication, in accordance with various aspects of the present application. As shown in FIG. 11, a node 1100 may include a transceiver 1120, a processor 1128, a memory 1134, one or more presentation components 1138, and at least one antenna 1136. The node 1100 may also include an RF spectrum band module, a base station communications module, a network communications module, and a system communications management module, Input/Output (I/O) ports, I/O components, and power supply (not explicitly shown in FIG. 11). Each of these components may be in communication with each other, directly or indirectly, over one or more buses 1140. In one implementation, the node 1100 may be a UE or a base station that performs various functions described herein, for example, with reference to FIGS. 1 through 10.

The transceiver 1120 having a transmitter 1122 (e.g., transmitting/transmission circuitry) and a receiver 1124 (e.g., receiving/reception circuitry) may be configured to transmit and/or receive time and/or frequency resource partitioning information. In some implementations, the transceiver 1120 may be configured to transmit in different types of subframes and slots including, but not limited to, usable, non-usable and flexibly usable subframes and slot formats. The transceiver 1120 may be configured to receive data and control channels.

The node 1100 may include a variety of computer-readable media. Computer-readable media can be any available media that can be accessed by the node 1100 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 1134 may include computer-storage media in the form of volatile and/or non-volatile memory. The memory 1134 may be removable, non-removable, or a combination thereof. Exemplary memory includes solid-state memory, hard drives, optical-disc drives, and etc. As illustrated in FIG. 11, the memory 1134 may store computer-readable, computer-executable instructions 1132 (e.g., software codes) that are configured to, when executed, cause the processor 1128 to perform various functions described herein, for example, with reference to FIGS. 1 through 10. Alternatively, the instructions 1132 may not be directly executable by the processor 1128 but be configured to cause the node 1100 (e.g., when compiled and executed) to perform various functions described herein.

The processor 1128 (e.g., having processing circuitry) may include an intelligent hardware device, e.g., a Central Processing Unit (CPU), a microcontroller, an ASIC, and etc. The processor 1128 may include memory. The processor 1128 may process the data 1130 and the instructions 1132 received from the memory 1134, and information through the transceiver 1120, the base band communications module, and/or the network communications module. The processor 1128 may also process information to be sent to the transceiver 1120 for transmission through the antenna 1136, to the network communications module for transmission to a core network.

One or more presentation components 1138 presents data indications to a person or other device. Exemplary presentation components 1138 include a display device, speaker, printing component, vibrating component, and etc.

From the above description, it is manifested that various techniques may be used for implementing the concepts described in the present application without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A method for a sidelink operation in unlicensed bands, performed by a user equipment (UE), the method comprising:
receiving a radio resource control (RRC) message that comprises a minimum gap between an earliest slot of a plurality of logical slots of physical sidelink feedback channels (PSFCHs) and a logical slot of a physical sidelink shared channel (PSSCH), wherein the plurality of logical slots of PSFCHs is assigned for the PSSCH;
receiving the PSSCH in an unlicensed channel;
attempting to transmit a feedback message in a first PSFCH of the PSFCHs in response to receiving the PSSCH, wherein attempting to transmit the feedback message in the first PSFCH comprises performing a first channel access procedure in the unlicensed channel before the first PSFCH; and
in a case that the first channel access procedure is not successful, attempting to transmit the feedback message in a second PSFCH of the PSFCHs, wherein attempting to transmit the feedback message in the second PSFCH comprises performing a second channel access procedure in the unlicensed channel before the second PSFCH.

2-8. (canceled)

9. A user equipment (UE) comprising:
a transceiver;
at least one processor; and
at least one non-transitory computer-readable medium coupled to the at least one processor and storing one or more computer-executable instructions that, when executed by the at least one processor, cause the UE to:
receive, through the transceiver, a radio resource control (RRC) message that comprises a minimum gap between an earliest slot of a plurality of logical slots of physical sidelink feedback channels (PSFCHs) and a logical slot of a physical sidelink shared channel (PSSCH), wherein the plurality of logical slots of PSFCHs is assigned for the PSSCH;
receive, through the transceiver, the PSSCH in an unlicensed channel;
attempt to transmit, through the transceiver, a feedback message in a first PSFCH of the PSFCHs in response to receiving the PSSCH, wherein attempting to transmit the feedback message in the first PSFCH comprises performing a first channel access procedure in the unlicensed channel before the first PSFCH; and
in a case that the first channel access procedure is not successful, attempt to transmit, through the transceiver, the feedback message in a second PSFCH of the PSFCHs, wherein attempting to transmit the feedback message in the second PSFCH comprises performing a second channel access procedure in the unlicensed channel before the second PSFCH.

10. The UE of claim 9, wherein:
the RRC message indicates a periodicity of the PSFCHs as N logical slots, and
a number of the plurality of logical slots of the PSFCHs is N−1.

11. The UE of claim 9, wherein the RRC message indicates a number of the plurality of logical slots of the PSFCHs.

12. The UE of claim 9, wherein logical slots of the plurality of logical slots of the PSFCHs do not overlap each other.

13. (canceled)

14. The UE of claim 9, wherein the one or more computer-executable instructions, when executed by the at least one processor, further cause the UE to:
receive, through the transceiver, sidelink control information (SCI), wherein:
the SCI comprises a feedback type of the PSFCHs, and
the feedback type is indicated as negative acknowledge (NACK)-only in response to the PSFCHs being transmitted by sharing a channel occupancy time (COT).

15. The UE of claim 9, wherein the one or more computer-executable instructions, when executed by the at least one processor, further cause the UE to:
apply a first channel access procedure type on the PSSCH or a physical sidelink control channel (PSCCH) in a slot n; and
apply a second channel access procedure type on the PSSCH or the PSCCH in a slot n+1 in response to one of the PSFCHs not being present in the slot n.

16. The UE of claim 9, wherein the one or more computer-executable instructions, when executed by the at least one processor, further cause the UE to:
receive, through the transceiver, sidelink control information (SCI), wherein the SCI indicates a channel access procedure type of one of the PSFCHs;
acquire a channel occupancy time (COT); and
apply the channel access procedure type on the one of the PSFCHs within the COT.

17. A base station comprising:
a transceiver;
at least one processor; and
at least one non-transitory computer-readable medium coupled to the at least one processor and storing one or more computer-executable instructions that, when executed by the at least one processor, cause the base station to:
transmit, through the transceiver, a radio resource control (RRC) message that comprises a minimum gap between an earliest slot of a plurality of logical slots of physical sidelink feedback channels (PSFCHs) and a logical slot of a physical sidekink shared channel (PSSCH) in an unlicensed channel, wherein the plurality of logical slots of PSFCHs is assigned for the PSSCH.

18. The base station of claim 17, wherein:
the RRC message indicates a periodicity of the PSFCHs as N logical slots, and
a number of the plurality of logical slots of the PSFCHs is N−1.

19. The base station of claim 17, wherein the RRC message indicates a number of the plurality of logical slots of the PSFCHs.

20. (canceled)
